(19) United States
(12) Patent Application Publication
(10) Pub. No.: US 2013/0232805 A1
(43) Pub. Date: Sep. 12, 2013

(54) MEASURING MACHINE PROVIDED WITH A SYSTEM FOR COMPENSATING MEASURING ERRORS DUE TO THERMAL EXPANSION OF A SCALE OF A LINEAR TRANSDUCER

(71) Applicant: HEXAGON METROLOGY S.P.A., Moncalieri (IT)

(72) Inventor: Domenico RUSSO, Moncalieri (IT)

(73) Assignee: HEXAGON METROLOGY S.P.A., Moncalieri (IT)

(21) Appl. No.: 13/787,302

(22) Filed: Mar. 6, 2013

(30) Foreign Application Priority Data
Mar. 7, 2012 (EP) 12425050.7

(51) Int. Cl. G01B 21/04

(52) U.S. Cl. CPC G01B 21/045
USPC 33/701; 33/702

(57) ABSTRACT

A measuring machine comprising a member mobile along an axis, an optical scale extending parallel to the axis, a first reading head, which is carried by the mobile member and co-operates with the optical scale, an additional sensor carried by the mobile member, and a processing unit co-operating with the first reading head and with the additional sensor for detecting data correlated with the state of thermal expansion of the optical scale.

The present invention relates to a measuring machine provided with a system for compensating measuring errors due to thermal expansion of a scale of a linear transducer.

### BACKGROUND OF THE INVENTION

As is known, measuring machines comprise members that are mobile along co-ordinate axes in order to displace a measuring sensor in a measuring volume. Typically, the mobile members are constituted by a first carriage mobile with respect to a bench along a first axis, a second carriage carried by the first carriage and mobile with respect thereto along a second axis orthogonal to the first, and a spindle carried by the second carriage and mobile with respect thereto along a third axis orthogonal to the first two.

The displacement of the mobile members is generally detected via a transducer comprising a scale fixed, along the axis of motion, to the supporting and guide member, and a reading head fixed to the mobile member and co-operating with the scale for detecting the co-ordinates along the axis of motion. The transducer can be of an optical, capacitive, or inductive type, or of some other type. For example, in the case of an optical transducer, the scale is provided with a series of notches at constant intervals (for example 20 μm) that are detected by the reading head 14 and “counted” by the logic associated thereto.

Measuring machines are generally equipped with systems for compensating the measuring errors due to various causes (geometrical errors of the guides, static or dynamic deformation of the mobile members of the machine, thermal expansion of said members, etc.).

Normally, compensation of the thermal expansion of the scale of the transducer is also envisaged, which is based upon the measurement of the temperature and upon the knowledge of the coefficient of expansion of the scale. For this purpose, the latter is preferably made of a material with a low coefficient of thermal expansion, or in any case of a material having a certified thermal expansion, which renders it costly.

### SUMMARY OF THE INVENTION

The aim of the present invention is to produce a measuring machine provided with an alternative system for compensating measuring errors due to thermal expansion of the scale of the linear transducer, as well as to a method for compensating said errors.

The aforesaid aim is achieved by a machine set forth in the claims.

### BRIEF DESCRIPTION OF THE DRAWINGS

For a better understanding of the present invention, three preferred embodiments are described in what follows by way of non-limiting examples and with reference to the attached drawings, wherein:

FIG. 1 is a schematic perspective view of a measuring machine provided with an optical scale and a system for compensating the measuring errors caused by thermal expansion of the optical scale;

FIG. 2 is a diagram illustrating a first embodiment of the compensation system;

FIG. 3 is a schematic illustration of a second embodiment of the compensation system, in a first operating condition;

FIG. 4 illustrates the system of FIG. 3, in a second operating condition;

FIG. 5 is a schematic illustration of a third embodiment of the compensation system, in a first operating condition; and

FIG. 6 illustrates the system of FIG. 5, in a second operating condition.

### DETAILED DESCRIPTION OF THE INVENTION

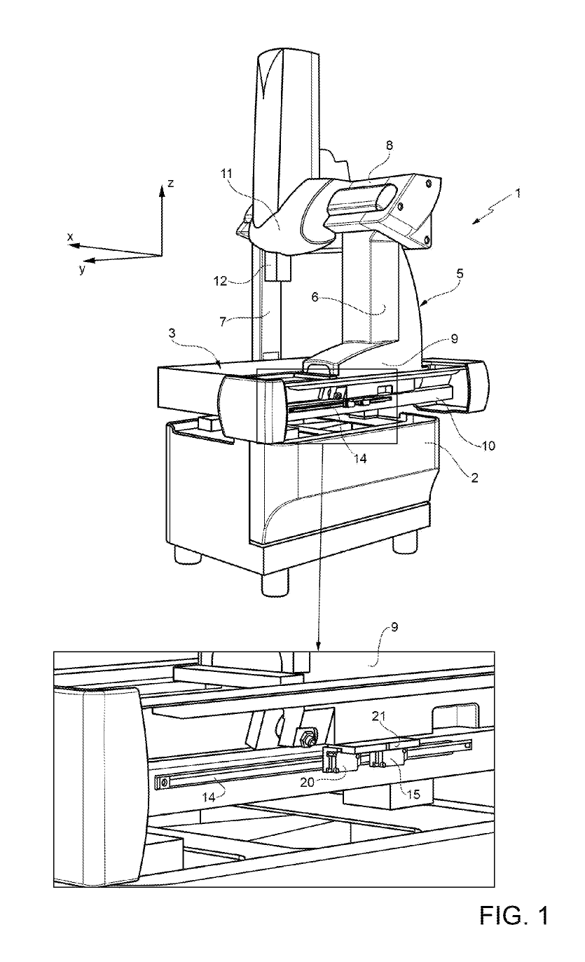

With reference to FIG. 1, designated as a whole by 1 is a co-ordinate measuring machine. The machine 1 comprises a bench 2 provided with a horizontal plane top surface 3 or reference surface. The machine 1 further comprises a motor-driven carriage 5 that slides on the bench 2 along a first horizontal axis (axis Y) of a cartesian reference system X, Y, Z of the measuring volume.

The carriage 5 has a bridge structure and comprises two vertical uprights 6, 7 and a top horizontal cross member 8 that extends between the top ends of the uprights 6, 7.

The upright 6 comprises at the bottom a motor-driven slide 9 sliding on guides 10 parallel to the axis Y and provided, in a known way, in the proximity of a top longitudinal edge of the bench 2.

The cross member 8 carries a second carriage 11 designed to slide thereon along guides (not illustrated) in a direction parallel to a second axis (axis X) of the reference system.

The second carriage 11 carries a spindle 12 with vertical axis, mobile along its own axis parallel to a third axis (axis Z) of the reference system. The spindle 12 is designed to carry at the bottom a measuring sensor (not illustrated).

The machine 1 comprises, for each axis, a linear transducer for detecting the position of the corresponding mobile member on the axis itself. With particular reference to the carriage 5 and to the axis Y, the linear transducer comprises an optical scale 14 fixed to the bench 2 parallel to the axis Y (see enlarged detail in FIG. 1), and a first reading head 15 fixed to the slide 9 and co-operating with the optical scale 14.

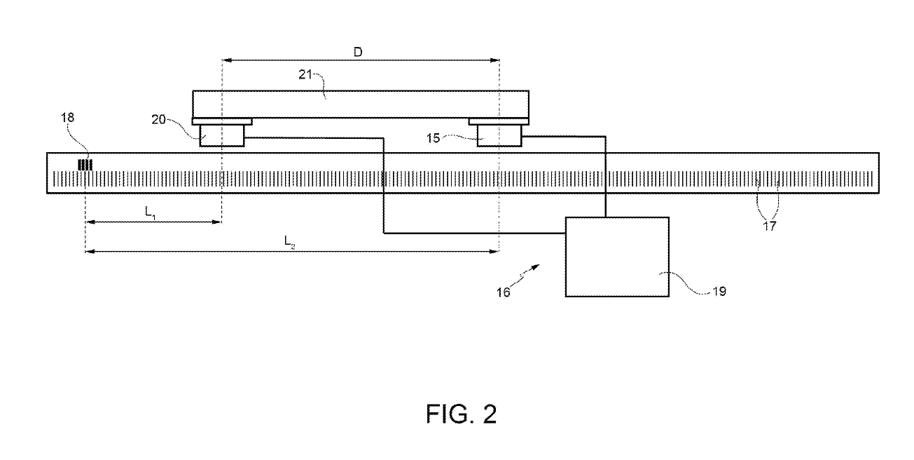

The optical scale 14 has, in a known way, a lattice of notches 17 arranged at regular intervals apart, for example every 20 μm, and a plurality of reference signs 18 arranged at greater intervals apart, for example 50 mm or 100 mm, just one of which is visible in FIG. 2, which can be used for resetting of the reading head 15.

According to the present invention, the machine 1 comprises a system 16 for determination and compensation of measuring errors due to thermal expansion of the optical scale 14. The system 16 basically comprises an additional sensor mounted on the slide 9 and a processing unit 19 connected to the first reading head 14 and the additional sensor.

In the embodiment illustrated in FIG. 2, the additional sensor is constituted by a second reading head 20 associated to the optical scale 14.

The first and second reading heads 15, 20 are spaced apart from one another along the axis Y by a known distance D. The distance D is known in so far as it can be considered substantially constant as the temperature varies or else varies in a known way therewith. For example, the two reading heads 15, 20 can be mounted on a bar 21 made of material with an extremely low coefficient of thermal expansion, such as Zerodur® (registered trademark of Schott AG), or else of a material having a known coefficient of thermal expansion. The bar 21 is conveniently mounted on the slide 9 so as to enable differential thermal expansion between the slide 9 and the bar itself.

The method for compensation of measuring errors due to thermal expansion of the optical scale 14 in the example illustrated is described in what follows.

In the first place, the reading heads 15 and 20 are reset at one and the same reference sign 18 on the optical scale 14. For this purpose, the carriage 5 is displaced in succession into a first position in which the sign 18 is read by the first reading head 15, and into a second position in which the sign 18 is read by the second reading head 20.

Once both of the reading heads 15, 20 have been reset on the same sign 18, the carriage 5 is displaced into a third position distinct from the previous ones (FIG. 2). Each of the reading heads 15, 20 detects its own position on the optical scale 14. The distance between the two heads 15, 20 can consequently be calculated as the difference between the respective readings L1, L2.

By comparing the known value of distance D with the difference between the readings L1 and L2, it is possible to calculate a scale factor

SF=D/(L1−L2) [1]

with which the co-ordinates detected by the machine in the measuring step can be corrected.

In the case where D is not constant with the temperature, Eq. [1] becomes

SF=D_{ref}(1+α(T−T_{ref}))/(L1−L2) [2]

where D_{ref}is the value of D at the reference temperature T_{ref}, for example 20° C.

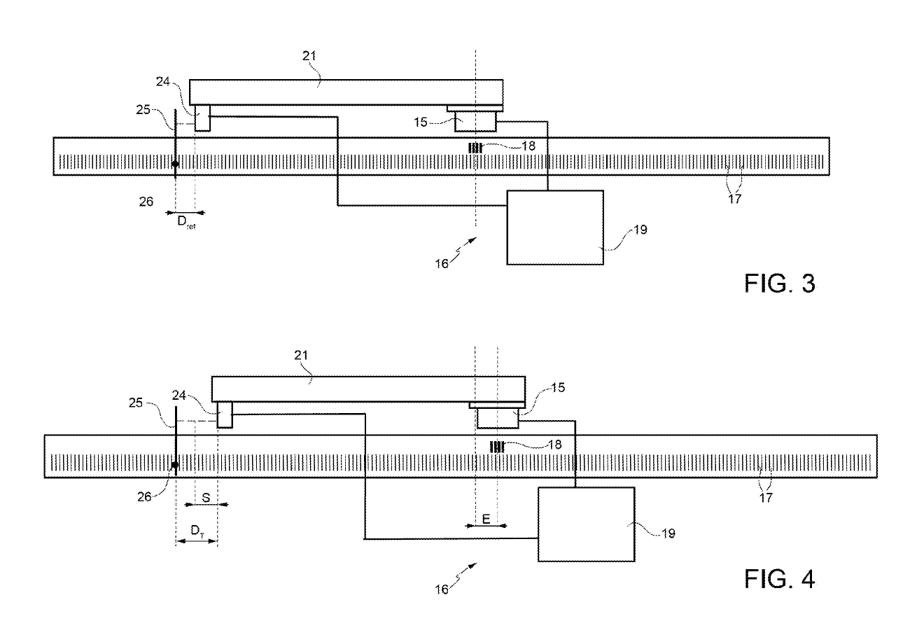

In the embodiment illustrated in FIG. 3, the additional sensor is constituted by a distance sensor 24 configured for measuring the distance from a fixed reference 25, which is fixed with respect to a point 26 of the optical scale 14 that is fixed with respect to the bench 2 of the machine 1.

This embodiment, which is more economically advantageous than the previous one in so far as the distance sensor is less costly than a reading head, requires an operation of initial calibration in conditions of reference temperature T_{ref} (FIG. 2), where the distance from the fixed reference D_{ref} is measured by the distance sensor with the carriage 5 set with the reading head 15 at a reference sign 18.

In conditions of operating temperature T (FIG. 4), before carrying out a measuring cycle, the method according to the invention envisages the steps of:
setting the carriage 5 with the reading unit 15 in the reference position at an operating temperature T;
measuring the distance D_{T} from the fixed reference by means of the distance sensor 24 at the operating temperature T;
calculating the difference S=D_{T}−D_{ref}, which, on the hypothesis that the distance between the reading head 15 and the sensor 24 is constant, is equal to the displacement E of the reference sign 18 with respect to the fixed point 26 of the optical scale 14 as a result of thermal expansion.

The value S can be used for calculating a correction value and correcting the measuring data detected by said machine by means of said correction value.

For instance, if M is the distance of the reference sign 18 from the fixed point 26 at the reference temperature, the correction value can be defined by a scale factor FS calculated by applying the expression

SF=M/(M−S) [3]

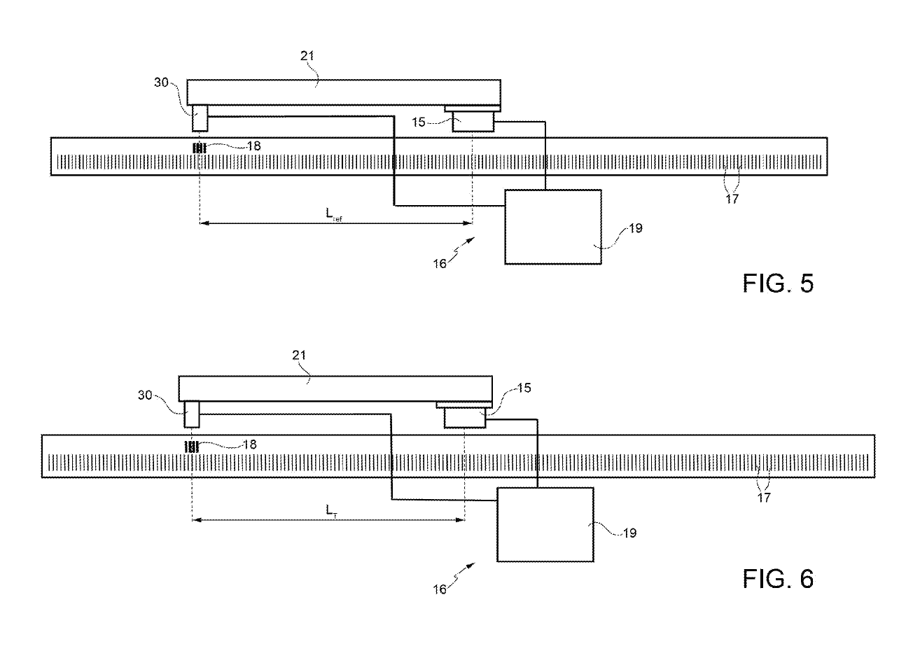

Illustrated in FIGS. 5 and 6 is a third embodiment of the present invention, where the additional sensor is constituted by an optical detector 30 configured so as to generate an enable signal 31 for reading the optical scale 14 by the reading head 15 when it detects the reference sign 18. In other words, reading of the optical scale 14 by the reading head 15 is “frozen” at the instant in which the optical detector 30 passes over the reference sign 18.

The operation is repeated at the reference temperature T_{ref} and the operating temperature T. Through the two readings L_{ref} and L of the reading head it is possible to determine the scale factor

FS=L_{ref}/L [4]

The formulas [3] and [4] refer to the hypothesis whereby the distance between the reading head and the additional sensor is constant. The formulas can be easily modified in the case where said distance cannot be assumed constant but varies with the temperature in a known way.

In each of the embodiments described, the scale factor FS constitutes a correction value by means of which the measurements made by the measuring machine and acquired via the processing unit 19 can be corrected to compensate for the errors induced by thermal expansion of the optical scale.

Finally, it is clear that modifications and variations may be made to the machine 1 and to the compensation system 16 illustrated herein, without thereby departing from the sphere of protection defined in the ensuing claims.

In particular, the machine can be of a type different from the one described, the compensation system can be applied to any mobile member of the machine, the additional sensor can be of any type, and the signals of the reading head and of the additional sensor can be processed in any suitable way to generate one or more correction values for compensating the measuring errors due to thermal expansion of the optical scale.

1. A measuring machine comprising:
at least one member mobile in a direction parallel to an axis; and
a linear transducer for detecting the position of said mobile member along said axis, the transducer including:
a scale extending parallel to said axis and a first reading head carried by the mobile member and co-operating with the scale; and
a system for compensating measuring errors due to thermal expansion of the scale comprising an additional sensor carried by said mobile member and processing means co-operating with the first reading head and with the additional sensor for detecting data correlated with the state of thermal expansion of the scale.

2. The machine according to claim 1, wherein the additional sensor includes a second reading head co-operating with said scale.

3. The machine according to claim 2, wherein the first and second reading heads are spaced apart from one another along said axis by a distance that does not vary with the temperature or varies in a known way therewith.

4. The machine according to claim 2, wherein said first and second reading heads are reset with respect to a common reference sign set on the scale.

5. The machine according to claim 1, wherein the additional sensor includes a distance sensor configured for measuring the distance from a fixed reference fixed with respect to a fixed point of said scale.

6. The machine according to claim 1, wherein the additional sensor includes a detector configured for detecting a reference sign on the scale, said processing means being configured for recording the reading of said first reading head when the detector detects said reference sign.

7. A method for correcting measuring errors due to thermal expansion of a scale of a linear transducer in a measuring machine, the machine comprising at least one member mobile in a direction parallel to the scale and a first reading head carried by said mobile member and co-operating with the scale, the method including using an additional sensor carried by said mobile member and processing means co-operating with the first reading head and with the additional sensor for detecting data correlated to the state of thermal expansion of the scale.

8. The method according to claim 7, wherein the additional sensor includes a second reading head co-operating with said scale and set at a distance from the first reading head that does not vary with the temperature or varies in a known way therewith, comprising the steps of:
setting the mobile member in a first reset position with the first reading head at a reference sign of the scale;
setting the mobile member in a second reset position of the second reading head at the same reference sign of the scale;
setting the mobile member in a third position;
calculating the distance between the first and second reading heads on the basis of the readings of said first and second reading heads in the third position;
calculating at least one correction value by comparing the distance calculated on the basis of the readings of said first and second heads in the third position with the value of the distance known or calculated as a function of the temperature; and
correcting the measuring data detected by said machine by means of said correction value.

9. The method according to claim 7, wherein the additional sensor includes a distance sensor configured for measuring the distance from a fixed reference fixed with respect to a fixed point of said scale, comprising the steps of:
setting the mobile member with the first reading head in a reference position in conditions of reference temperature;
measuring the distance from the fixed reference by means of said distance sensor in said condition of reference temperature;
setting the mobile member with the first reading unit in the reference position at an operating temperature;
measuring the distance from the fixed reference by means of said distance sensor in said condition of operating temperature;
calculating at least one correction value on the basis of the values of distance detected at the reference temperature and at the operating temperature; and
correcting the measuring data detected by said machine by means of said correction value.

10. The method according to claim 7, wherein the additional sensor includes a detector configured for detecting a reference sign on said scale, comprising the steps of:
acquiring a first reading with the first reading head in response to detection of the reference sign by the detector in conditions of reference temperature;
acquiring a second reading with the first reading head in response to detection of the reference sign by the detector in conditions of operating temperature;
calculating at least one correction value on the basis of said first and second readings; and
correcting the measuring data detected by said machine by means of said correction value.
